(19) United States
(12) Patent Application Publication
(10) Pub. No.: US 2005/0060491 A1
(43) Pub. Date: Mar. 17, 2005

(54) Method and apparatus for capturing data and data capture program

(76) Inventor: Kenichiro Ayaki, Saitama (JP)

Correspondence Address: BIRCH STEWART KOLASCH & BIRCH, PO BOX 747, FALLS CHURCH, VA, 22040-0747, US

(21) Appl. No.: 10/941,978

(22) Filed: Sep. 16, 2004

(30) Foreign Application Priority Data
Sep. 17, 2003 (JP) 2003-325070

(51) Int. Cl. G06F 12/00

(52) U.S. Cl. 711/115

(57) ABSTRACT

A personal computer displays a confirmation window on a screen of a monitor after capturing image data from a memory card of a digital camera. When the digital camera is not loaded with the memory card or when the image data does not exist in the memory card, the confirmation window is also shown to have a user select either of connection and disconnection with the digital camera. When “YES” is selected in the confirmation window, a CPU of the personal computer automatically executes unmount processing by which access to the memory card is put in an off-line state. After the unmount processing, the personal computer displays a permission window on the screen of the monitor to notify the user that disconnecting the digital camera is allowed.

### BACKGROUND OF THE INVENTION

1. Field of the Invention

The present invention relates to a method, an apparatus and a program for capturing image data or the like in a computer from a card reader and so forth in which storage media, for example memory cards, are set.

2. Description of the Related Art

Along with the rapid popularization of digital cameras, many users capture images, which are taken by the digital camera, in a personal computer (PC) and print out the images with a printer to view them.

When the image data is captured, the PC is connected to the digital camera itself or an exclusive card reader comprising a slot to be loaded with a memory card. The image data is automatically captured by accessing the digital camera and the memory card set in the reader.

In order to increase storage capacity, some of the digital cameras and the card readers are capable of being loaded with a plurality of memory cards. As to an apparatus to be connected to such a reader and to capture the data in the computer from the storage media of the reader, Japanese Patent Laid-Open Publication No. 2003-50725 proposes a storage-device control apparatus, which is capable of recognizing and accessing a plurality of storage devices as a single storage device.

By the way, unmount processing for putting the access to the memory card into an off-line state is performed after capturing the image data from the memory card. The unmount processing is manually performed by a user such that an icon, which is displayed on a screen of a PC monitor to represent the memory card and the card reader, is dropped into a trash icon. Thus, there is a problem in that the unmount processing is troublesome. Further, it is difficult to know the timing for disconnecting the digital camera and the card reader. Therefore, it is hard to say that usability is good for computing newcomers.

### SUMMARY OF THE INVENTION

In view of the foregoing, it is a primary object of the present invention to provide a method and an apparatus for capturing data, by which user-friendliness may be improved.

It is a second object of the present invention to provide a data capture program by which user-friendliness may be improved.

In order to achieve the above and other objects, the data capturing method according to the present invention comprises a step of connecting a computer with a reader to which storage media are removably set. The data capturing method further comprises a step of detecting whether or not data to be captured exists in the storage media, on the basis of access performed by the computer relative to each of the storage media contained in the reader. When the data to be captured exists in the storage medium, the data is captured into the computer. After fully capturing the data, unmount processing is automatically executed to put the access to all of the storage media in an off-line state. After the unmount processing, it is indicated that disconnecting the computer and the reader is allowed.

In a preferred embodiment, whether or not the reader should be disconnected is indicated before the unmount processing is executed. Moreover, it is preferable that the storage medium is a memory card for a digital camera, and the data is image data taken by the digital camera, and the reader is either of the digital camera and a card reader. Further, it is preferable that the indication is performed by displaying a message on a monitor of the computer.

The data capturing apparatus according to the present invention comprises a detecting part for accessing storage media contained in a reader to detect whether or not data to be captured exists in the storage media. The data capturing apparatus further comprises a data capturing part for performing a data capture processing relative to the storage medium in which the data to be captured exists. After fully capturing the data to be captured, unmount processing is automatically executed to put the access to all of the storage media in an off-line state. The data capturing apparatus further comprises an indicating part for indicating, after the unmount processing, that it is possible to disconnect the reader.

In a preferred embodiment, the indicating part indicates, before the unmount processing, whether or not the reader should be disconnected. Moreover, it is preferable that the storage medium is a memory card for a digital camera, and the data is image data taken by the digital camera, and the reader is either of the digital camera and a card reader. Further, it is preferable that the indicating part is a monitor of the computer.

The data capture program according to the present invention activates a computer to perform steps of accessing each of storage media removably set in a reader, and detecting whether or not data to be captured exists in the storage media. When the data to be captured exists in the storage medium, the data capture program activates the computer to perform a step of capturing the data into the computer connected with the reader. After capturing the data, the data capture program activates the computer to perform a step of automatically executing unmount processing for putting the access to all of the storage mediain an off-line state. After the unmount processing, the data capture program activates the computer to perform a step of indicating that disconnecting the reader is allowed.

In a preferred embodiment, before the unmount processing is executed, the data capture program activates the computer to perform a step of indicating whether or not the reader should be disconnected. Moreover, it is preferable that the storage medium is a memory card for a digital camera, and the data is image data taken by the digital camera, and the reader is either of the digital camera and a card reader. Further, it is preferable that the indication is performed by displaying a message on a monitor of the computer.

According to the present invention, the data is captured when the data to be captured exists in the storage medium, and the unmount processing is automatically executed. Thus, the user-friendliness may be improved.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is an illustration showing a state in that a digital camera is connected to a personal computer adopting the present invention;

FIG. 2 is a block diagram showing an electrical structure of the personal computer;

FIG. 3 is a block diagram showing an electrical structure of the digital camera;

FIG. 4 is an explanatory illustration showing contents of a folder storing captured image data;

FIG. 5 is an explanatory illustration showing a confirmation window;

FIG. 6 is an explanatory illustration showing a permission window;

FIG. 7 is a flowchart showing a sequence of data processing executed in the personal computer; and

FIG. 8 is a flowchart showing the sequence of data processing executed in the personal computer.

### DETAILED DESCRIPTION OF THE PREFERRED EMBODIMENT(S)

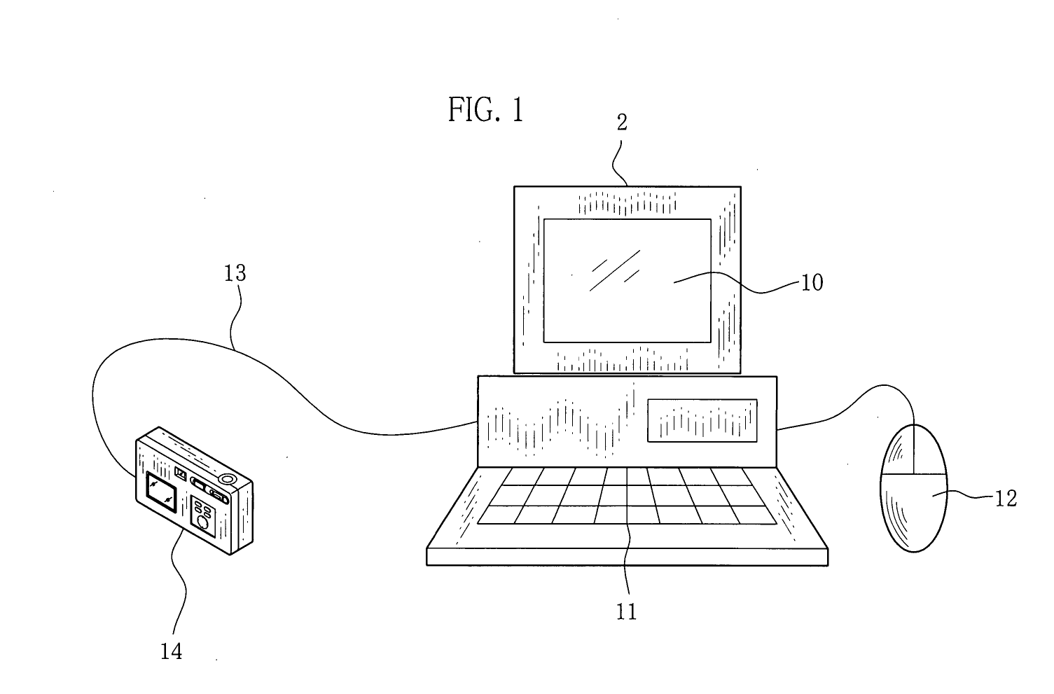

In FIG. 1, a personal computer (PC) 2 according to the present invention comprises a monitor 10, a keyboard 11 and a mouse 12. The PC 2 is connectable to a digital camera 14 via a USB (Universal Serial Bus) cable 13.

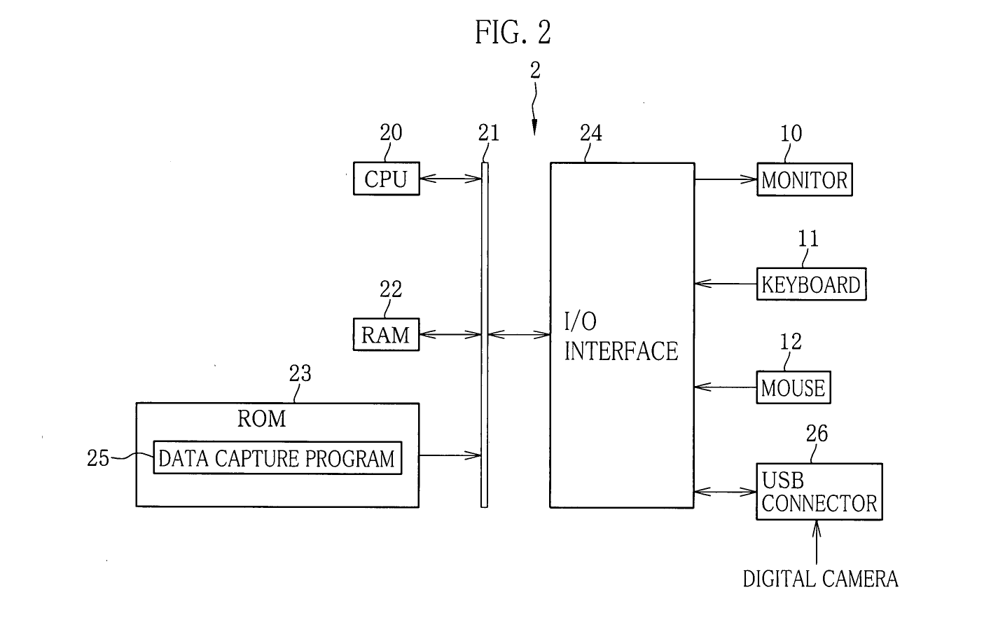

Such as shown in FIG. 2, an entire operation of the PC 2 is controlled by a CPU 20. The CPU 20 is connected with a RAM 22, a ROM 23 and an I/O interface 24 via a bus 21. A program necessary for booting the PC 2 is installed in the ROM 23. In addition, a data capture program is installed in the ROM 23. The data capture program is used for automatically capturing an image taken by the digital camera 14. The RAM 22 stores captured image data. The I/O interface 24 is connected with a USB connector 26, to which the USB cable 13 is fixed, in addition to the monitor 10, the keyboard 11 and the mouse 12.

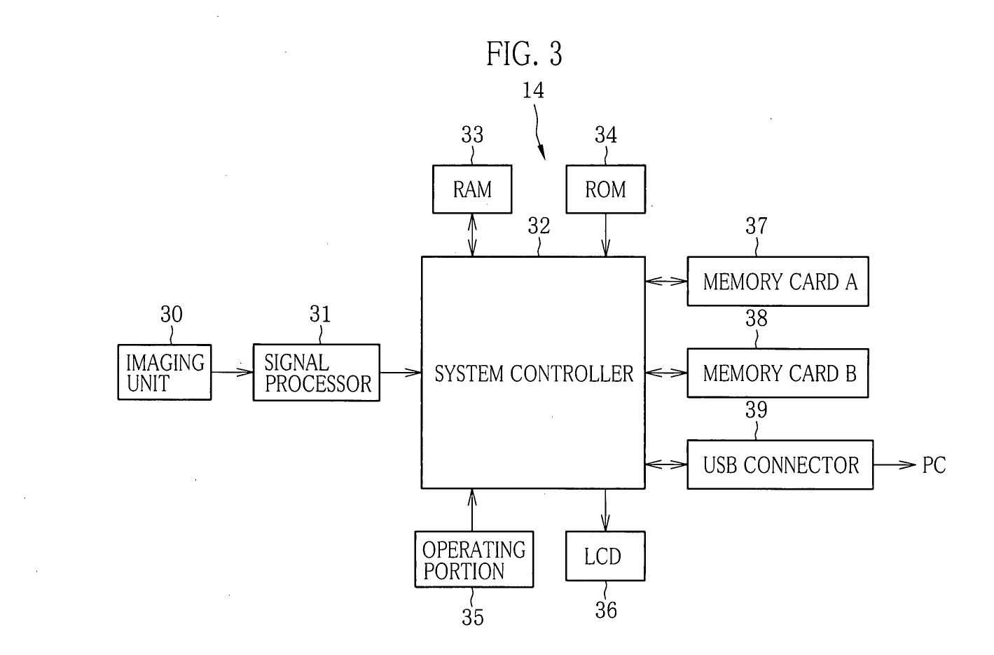

In FIG. 3, the digital camera 14 is constituted of an imaging unit 30, a signal processor 31, a system controller 32 and so forth. The imaging unit 30 includes an imaging lens and a CCD image sensor, and subject light having entered through the imaging lens is converted into an image signal by the CCD image sensor. For the image signal outputted from the imaging unit 30, the signal processor 31 executes various kinds of signal processing of an A/D conversion processing and so forth. The signal processor 31 converts the image signal into digital image data and transfers this data to the system controller 32.

The system controller 32 executes various kinds of image processing, for example gradation conversion, white balance correction and gamma correction processing, for the digital image data transferred from the signal processor 31. The system controller 32 is connected with a RAM 33, a ROM 34, an operating portion 35, a liquid-crystal display (LCD) 36, a memory card A 37, a memory card B 38 and a USB connector 39.

The ROM 34 stores various kinds of control programs, configuration information and so forth. The system controller 32 retrieves the information from the ROM 34 to the RAM 33 being as a work memory to execute various kinds of processing. The RAM 33 acts not only as the work memory but also as a buffer memory for temporarily storing the digital image data outputted from the signal processor 31.

The operating portion 35 includes a power switch, a release button, a zoom switch, a menu button, a cursor button and a determination button. The power switch turns on and off a power source of the digital camera 14. The release button is handled at the time of shutter release. The zoom switch changes a zoom magnification of the imaging lens. The menu button displays a menu picture on the LCD 36. The cursor button moves a cursor within the menu picture. The determination button is handled when a selection is determined. The system controller 32 controls the respective sections of the digital camera 14 in association with handling of the operating portion 35.

The LCD 36 displays taken images, so-called through images, and various kinds of menu pictures. The memory card A 37 and the memory cards B 38 store the image data for which the various kinds of image processing have been executed in the system controller 32 and which is compressed in a prescribed format (JPEG format, for example). When available memory of the memory card A 37 has run out, the memory card B 38 is successively used. Incidentally, the memory card A 37 and the memory card B 38 may be same kind or may be different kind. As to the kind of the memory card, there are xD-picture card, SD card, smart media, compact flash (registered trade mark), memory stick (each of which is a trade name) and so forth.

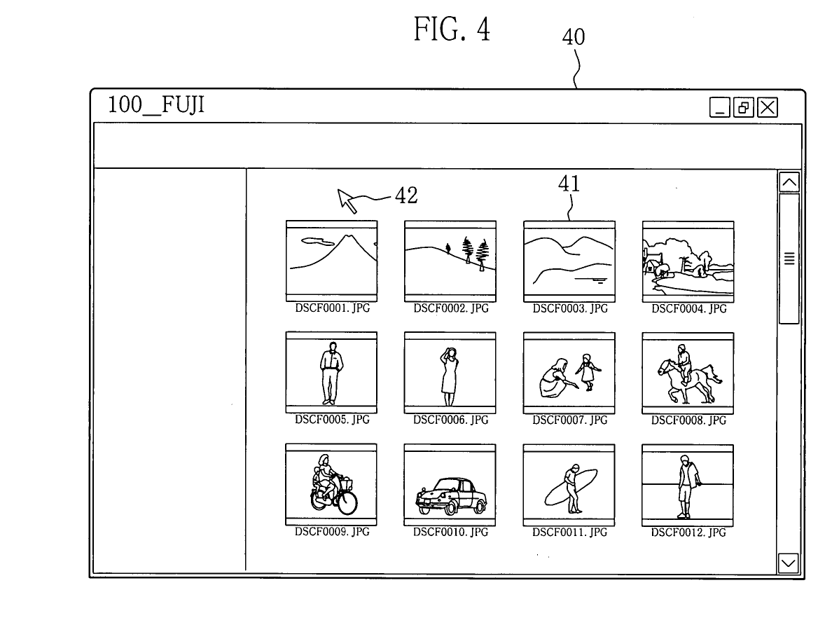

Whenever the image data is stored in the memory card, the system controller 32 gives a proper file name (serial number continuing in a photographic order) to the image data. For example, “DSCF0001A.JPG”, “DSCF0002A.JPG”, etc. are given to the image data stored in the memory card A 37, and “DSCF0001B.JPG”, “DSCF0002B.JPG”, etc. are given to the image data stored in the memory card B 38 (see FIG. 4). These are stored in the same folder. By the way, the extension “.JPG” of the file mane represents that the image data is compressed in the JPEG format. Meanwhile, when moving-image data is stored, audio data (of which the extension is “.AVI”) attached thereto is also stored so as to be related to the image data.

The USB connector 39 is connected to the USB cable 13 to transfer the image data from the memory cards 37 and 38 to the PC 2. The image data stored in the memory cards 37 and 38 are automatically captured into the RAM 22 by the PC 2 through the USB connector 39, the USB cable 13 and the USB connector 26.

The image data captured into the RAM 22 of the PC 2 is arranged within one folder 40 in an order of the file name, and is displayed as so-called thumbnail images 40 on a screen of the monitor 10, such as shown in FIG. 4. Upon pointing a cursor 42 to one of the thumbnail images 41 and double-clicking the mouse 12, are view image thereof is displayed on the screen of the monitor 10.

When it is detected that the digital camera 14 is connected via the USB connector 26, a data capture program 25 is started. After starting the data capture program 25, the CPU 20 executes mount processing by which accessing the memory cards 37 and 38 is allowed. Moreover, the CPU 20 detects whether or not the digital camera 14 is loaded with the memory card 37.

When the digital camera 14 is loaded with the memory card 37, the CPU 20 detects whether or not the image data exists in the memory card 37. When the image data exists in the memory card 37, the image data is automatically captured into the RAM 22 such as described above.

After capturing the image data stored in the memory card 37, the CPU 20 detects whether or not the digital camera 14 is loaded with the other memory card 38. When the digital camera 14 is loaded with the memory card 38, the CPU 20 detects whether or not the image data exists in the memory card 38, similarly to the case of the memory card 37. When the image data exists in the memory card 38, the image data is automatically captured into the RAM 22.

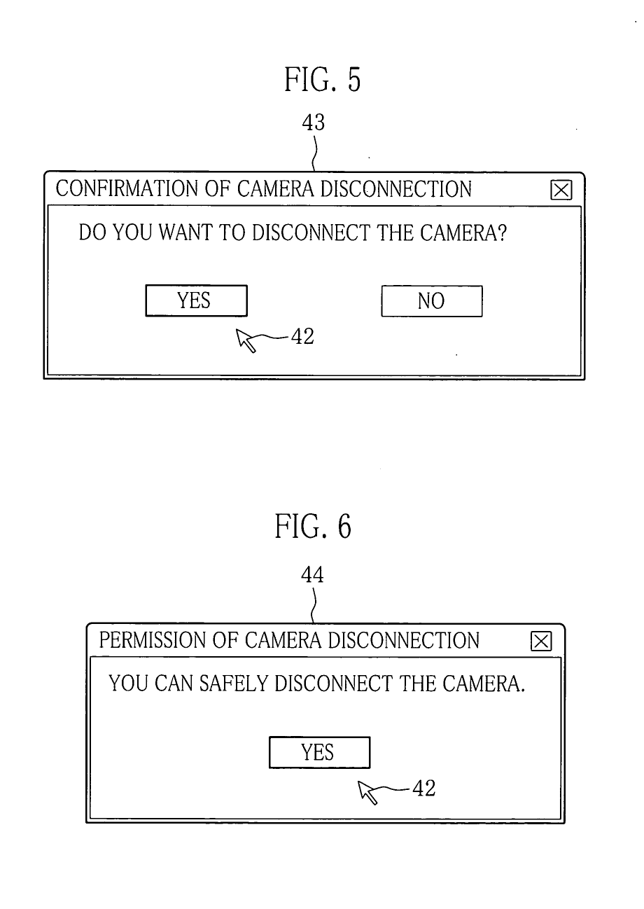

After capturing the image data, the PC 2 indicates a confirmation window 43, which is shown in FIG. 5 as an example, on the screen of the monitor 10 to have a user select either of connection and disconnection with the digital camera 14. In the meantime, when the digital camera 14 is not loaded with the memory card or when the image data does not exist in the memory card, the PC 2 also indicates the confirmation window 43 to have the user select either of connection and disconnection with the digital camera 14.

When YES is selected in the confirmation window 43, the CPU 20 automatically executes unmount processing by which the access to the memory cards 37 and 38 is put in an off-line state. After the unmount processing, the PC 2 indicates a permission window 44, which is shown in FIG. 6 as an example, on the screen of the monitor 10 to notify the user that disconnecting the digital camera 14 is allowed. Meanwhile, when “NO” is selected in the confirmation window 43, the CPU 20 does not execute the unmount processing so that accessing the memory cards 37 and 38 is continued.

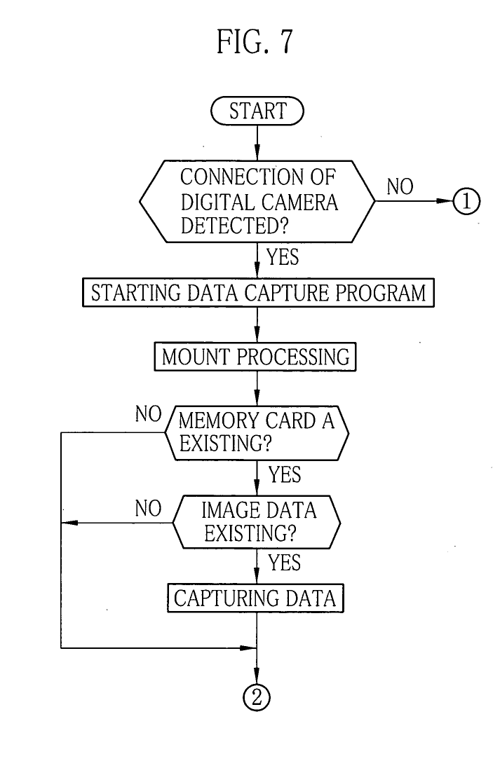

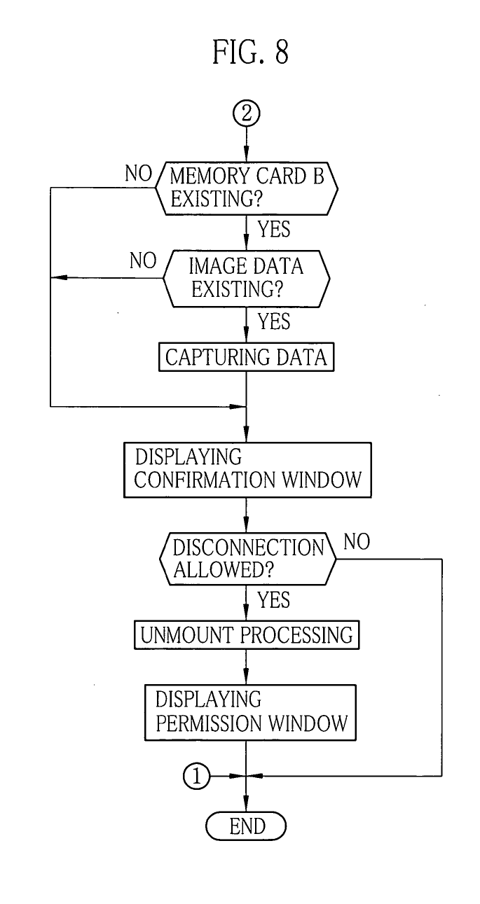

Next, an operation of the above embodiment is described below, referring to flowcharts shown in FIGS. 7 and 8. First of all, the PC 2 and the digital camera 14 are connected via the USB cable 13. Then, a power source of the digital camera 14 is turned on. When it is detected that the digital camera 14 is connected via the USB connector 26, the data capture program 25 is started.

After starting the data capture program 25, the CPU 20 executes the mount processing to allow accessing the memory cards 37 and 38. Further, it is detected whether or not the digital camera 14 is loaded with the memory card 37.

When the digital camera 14 is loaded with the memory card 37, it is detected whether or not the image data exists in the memory card 37. When the image data exists in the memory card 37, the image data is automatically captured into the RAM 22.

Meanwhile, when the digital camera 14 is not loaded with the memory card 37 or when the image data does not exist in the memory card 37, the next processing is executed without capturing the data.

After capturing the image data stored in the memory card 37, it is detected whether or not the digital camera 14 is loaded with the other memory card 38. When the digital camera 14 is loaded with the memory card 38, it is detected whether or not the image data exists in the memory card 38, similarly to the case of the memory card 37. When the image data exists in the memory card 38, the image data is automatically captured into the RAM 22.

Meanwhile, when the digital camera 14 is not loaded with the memory card 38 or when the image data does not exist in the memory card 38, the next processing is executed without capturing the image data.

After capturing the image data, the confirmation window 43 is displayed on the screen of the monitor 10 to notify the user about whether or not the digital camera 14 is disconnected. In the meantime, when the digital camera 14 is not loaded with the memory card or when the image data does not exist in the memory card, the confirmation window 43 is also displayed to notify the user about whether or not the digital camera 14 is disconnected.

When YES is selected in the confirmation window 43, the CPU 20 automatically executes the unmount processing by which the access to the memory cards 37 and 38 is put in the off-line state. After the unmount processing, the permission window 44 is displayed on the screen of the monitor 10 to notify the user that disconnecting the digital camera 14 is allowed. In the meantime, when NO is selected in the confirmation window 43, accessing the memory cards 37 and 38 is continued without executing the unmount processing.

In virtue of the above structure, the user may disconnect the digital camera 14, just following the instructions of the confirmation window 43 and the permission window 44. It is possible to smoothly and safely complete the capture of the image data from the digital camera 14 to the PC 2. Meanwhile, when “NO” is selected in the confirmation window 43, accessing the memory cards 37 and 38 is continued so that it is possible to deal with a case in that the user desires to independently read and write the data.

The above embodiment is described with the example of the double memory cards. However, the number of the memory cards may be more than two. Further, whether nor not the digital camera 14 is loaded with the memory cards 37 and 38 may be simultaneously detected after executing the mount processing.

Incidentally, the unmount processing may be executed just after capturing the image data without displaying the confirmation window 43 on the screen of the monitor 10. The forgoing embodiment is described with the example in that the image data is captured from the digital camera 14 to the PC 2. However, the present invention is not exclusive to this, but is also applicable to a case in that the image data is captured from a dedicated card reader to a photo printer, for example.

As to the storage medium, the memory card is not exclusive. The present invention is also effective for a case in that the data is captured from the other storage media of a CD-R, a hard disk and so forth. Further, the data to be captured is not exclusive to the image data, but may be text data of textual information and audio data.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A data capturing method for capturing data, which is stored in a plurality of storage media, into a computer, said data capturing method comprising the steps of:
connecting said computer with a reader to which said storage media are removably set;
detecting whether or not the data to be captured exists in said storage media, on the basis of access performed by said computer relative to each of said storage media contained in said reader;
capturing said data into said computer when the data to be captured exists in said storage medium;
automatically executing unmount processing after fully capturing the data to be captured, said unmount processing putting the access, which is performed by said computer relative to the respective storage media, in an off-line state; and
indicating that disconnecting said computer and said reader is allowed, after said unmount processing.

2. A data capturing method according to claim 1, further comprising the step of:
indicating before said unmount processing whether or not said reader should be disconnected.

3. A data capturing method according to claim 1, wherein said storage medium is a memory card for a digital camera, and said data is image data taken by said digital camera, and said reader is one of said digital camera and a card reader.

4. A data capturing method according to claim 3, wherein said image data is captured into said computer via USB connectors, which are respectively provided in said computer and said digital camera, and a USB cable for connecting said USB connectors.

5. A data capturing method according to claim 1, wherein the indication of allowance is performed by displaying a message on a monitor of said computer.

6. A data capturing apparatus for capturing data from a plurality of storage media, said data capturing apparatus being connected with a reader to which said storage media are removably set, said data capturing apparatus comprising:
a detecting part for accessing said storage media contained in said reader to detect whether the data to be captured exists or not;
a data capturing part for performing a data capture processing relative to said storage medium in which the data to be captured exists;
an unmount processing part for executing unmount processing, after fully capturing the data to be captured, to put access of all of said storage media in an off-line state; and
an indicating part for indicating, after said unmount processing, that it is possible to disconnect said reader.

7. A data capturing apparatus according to claim 6, wherein said data capturing apparatus is a computer.

8. A data capturing apparatus according to claim 7, wherein said indicating part further indicates, before said unmount processing, whether or not said reader should be disconnected.

9. A data capturing apparatus according to claim 7, wherein said storage medium is a memory card for a digital camera, and said data is image data taken by said digital camera, and said reader is one of said digital camera and a card reader.

10. A data capturing apparatus according to claim 9, wherein said image data is captured into said computer via USB connectors, which are respectively provided in said computer and said digital camera, and a USB cable for connecting said USB connectors.

11. A data capturing apparatus according to claim 7, wherein said indicating part is a monitor of said computer, and an indication of said indicating part is performed by displaying a message on said monitor.

12. A data capture program for capturing data, which is stored in a plurality of storage media, into a computer connected with a reader to which said storage media are removably set, said data capture program activating said computer to execute the steps of:
accessing each of said storage media contained in said reader to detect whether or not the data to be captured exists in said storage media;
capturing said data into said computer when the data to be captured exists in said storage media;
automatically executing unmount processing by which access to all of the storage media is put in an off-line state; and
indicating, after said unmount processing, that disconnecting the reader is allowed.

13. A data capture program according to claim 12, wherein said computer is activated to further execute the step of:
indicating before said unmount processing whether or not said reader should be disconnected.

14. A data capture program according to claim 12, wherein said storage medium is a memory card for a digital camera, and said data is image data taken by said digital camera, and said reader is one of said digital camera and a card reader.

15. A data capture program according to claim 14, wherein said image data is captured into said computer via USB connectors, which are respectively provided in said computer and said digital camera, and a USB cable for connecting said USB connectors.

16. A data capture program according to claim 12, wherein the indication of allowance is performed by displaying a message on a monitor of said computer.
